(19) United States
(12) Patent Application Publication
(10) Pub. No.: US 2013/0095860 A1
(43) Pub. Date: Apr. 18, 2013

(54) MOBILE COMMUNICATION METHOD, MOBILE STATION, RADIO BASE STATION, AND UPPER NODE

(71) Applicants: Wuri Andarmawanti Hapsari, Chiyoda-ku (JP); Anil Umesh, Chiyoda-ku (JP); Mikio Iwamura, Chiyoda-ku (JP); Hideaki Takahashi, Chiyoda-ku (JP); Minami Ishii, Chiyoda-ku (JP)

(72) Inventors: Wuri Andarmawanti Hapsari, Chiyoda-ku (JP); Anil Umesh, Chiyoda-ku (JP); Mikio Iwamura, Chiyoda-ku (JP); Hideaki Takahashi, Chiyoda-ku (JP); Minami Ishii, Chiyoda-ku (JP)

(73) Assignee: NTT DOCOMO, INC., Tokyo (JP)

(21) Appl. No.: 13/639,558

(22) PCT Filed: Apr. 5, 2011
(86) PCT No.: PCT/JP2011/058622

§ 371 Date: Dec. 19, 2012

(30) Foreign Application Priority Data
Apr. 5, 2010 (JP) 2010-087403

(51) Int. Cl. H04W 24/10; H04W 4/02

(52) U.S. Cl. CPC H04W 24/10; H04W 4/02
USPC 455/456.5

(57) ABSTRACT

A mobile communication method according to the present invention includes a step of instructing a target mobile station UE, by a radio base station eNB, to perform “MDT” based on an “MDT policy”, a step of acquiring, by the target mobile station UE, from a positioning server E-SMLC, the location information of the target mobile station UE, and a step of transmitting, by the target mobile station UE, to the radio base station eNB, the measurement result of the desired radio quality and the location information of the target mobile station UE.

### TECHNICAL FIELD

The present invention relates to a mobile communication method, a mobile station, a radio base station, and an upper node.

### BACKGROUND ART

In a conventional mobile communication system, in order to improve the radio quality, a communication carrier measured and investigated the radio quality in each area by performing a “Drive Test”.

### CITATION LIST

### Non Patent Literature

[NPL 1] 3GPP TR36.805, “Evolved Universal Terrestrial Radio Access (E-UTRA); Study on minimization of drive-tests in next generation networks”

[NPL 2] 3GPP TS37.320, “Radio measurement collection for MDT”

However, according to the “Drive Test”, a communication carrier is required to measure and investigate the radio quality in all areas, find out the area with a problem, and then improve the radio quality based on the result of measurement and investigation of the radio quality, which poses the problem of a high cost.

In order to resolve this problem, 3GPP discusses a technique called “MDT (Minimization of Drive Tests)” in which a target mobile station UE is caused to measure and report a desired radio quality.

### SUMMARY OF THE INVENTION

Thus, the present invention has been achieved in view of the aforementioned problem, and an object thereof is to provide a mobile communication method with which it is possible to acquire accurate location information of a target mobile station UE, along with a measurement result, by causing the target mobile station UE to measure accurately a desired radio quality, and to provide a mobile station thereof, a radio base station thereof, and an upper node thereof.

A first characteristic of the present invention is summarized as a mobile communication method in which a target mobile station is caused to measure and report a desired radio quality, and which includes a step of instructing the target mobile station, by a radio base station, to measure and report the desired radio quality based on a method of measuring and reporting the desired radio quality, a step of acquiring, by the target mobile station, from a positioning server, the location information of the target mobile station, and a step of transmitting, by the target mobile station, to the radio base station, the measurement result of the desired radio quality and the location information of the target mobile station.

A second characteristic of the present invention is summarized as a mobile station capable of functioning as a target mobile station in a mobile communication method in which the target mobile station is caused to measure and report a desired radio quality, and which includes a location information acquisition unit configured to acquire the location information of the target mobile station, from a positioning server, when instructed to measure and report the desired radio quality based on a method of measuring and reporting the desired radio quality, and a transmission unit configured to transmit, to a radio base station, the measurement result of the desired radio quality and the location information of the target mobile station.

A third characteristic of the present invention is summarized as a mobile communication method in which a target mobile station is caused to measure and report a desired radio quality, and which includes a step of acquiring, from a positioning server, the location information of the target mobile station, when a radio base station instructs the target mobile station to measure and report the desired radio quality based on a method of measuring and reporting the desired radio quality, a step of transmitting, by the target mobile station, to the radio base station, the measurement result of the desired radio quality, and a step of transmitting, by the radio base station, to an upper node, the measurement result of the desired radio quality received from the target mobile station, and the location information of the target mobile station acquired from the positioning server.

A fourth characteristic of the present invention is summarized as a radio base station used in a mobile communication method in which a target mobile station is caused to measure and report a desired radio quality, and which includes a location information acquisition unit configured to acquire the location information of the target mobile station, from a positioning server, when the target mobile station is instructed to measure and report the desired radio quality based on a method of measuring and reporting the desired radio quality, and a transmission unit configured to transmit, to an upper node, the measurement result of the desired radio quality received from the target mobile station, and the location information of the target mobile station acquired from the positioning server.

A fifth characteristic of the present invention is summarized as a mobile communication method in which a target mobile station is caused to measure and report a desired radio quality, and which includes a step of acquiring, from a positioning server, the location information of the target mobile station, when an upper node notifies a method of measuring and reporting the desired radio quality to a radio base station, a step of instructing the target mobile station, by the radio base station, to measure and report the desired radio quality based on the method of measuring and reporting the desired radio quality, a step of transmitting, by the target mobile station, to the radio base station, the measurement result of the desired radio quality, and a step of transmitting, by the radio base station, to the upper node, the measurement result of the desired radio quality received from the target mobile station.

A sixth characteristic of the present invention is summarized as an upper node used in a mobile communication method in which a target mobile station is caused to measure and report a desired radio quality, and which includes a location information acquisition unit configured to acquire the location information of the target mobile station, from a positioning server, when the radio base station is notified of a method of measuring and reporting the desired radio quality, and a reception unit configured to receive the measurement result of the desired radio quality from the target mobile station via the radio base station.

As described above, according to the present invention, it is possible to provide a mobile communication method with which it is possible to acquire accurate location information of a target mobile station UE, along with a measurement result, by causing the target mobile station UE to measure accurately a desired radio quality, and to provide a mobile station thereof, a radio base station thereof, and an upper node thereof.

### BRIEF DESCRIPTION OF DRAWINGS

FIG. 1 is a diagram showing the entire configuration of a mobile communication system according to a first embodiment of the present invention.

FIG. 2 is a functional block diagram of a mobile station according to the first embodiment of the present invention.

FIG. 3 is a sequence diagram illustrating an operation of the mobile communication system according to the first embodiment of the present invention.

FIG. 4 is a functional block diagram of a radio base station according to a second embodiment of the present invention.

FIG. 5 is a sequence diagram illustrating an operation of a mobile communication system according to the second embodiment of the present invention.

FIG. 6 is a functional block diagram of a mobile switching center and an operation and maintenance server according to a third embodiment of the present invention.

FIG. 7 is a sequence diagram illustrating an operation of a mobile communication system according to the third embodiment of the present invention.

### DESCRIPTION OF EMBODIMENTS

(Mobile Communication System According to First Embodiment of the Present Invention)

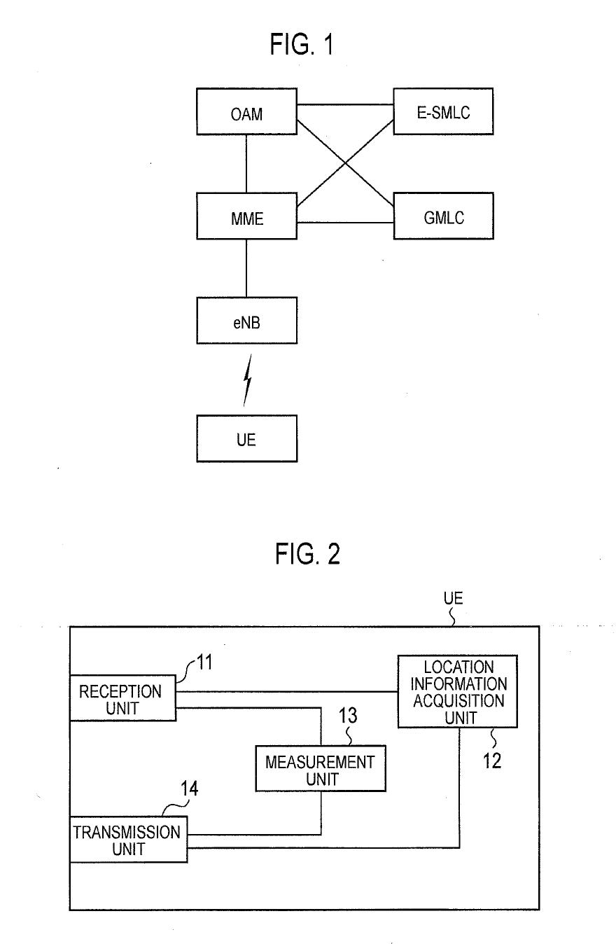

With reference to FIG. 1 to FIG. 3, a mobile communication system according to a first embodiment of the present invention will be described.

As illustrated in FIG. 1, the mobile communication system according to the present embodiment includes a positioning server E-SMLC (Evolved-Serving Mobile Location Centre), a positioning server GMLC (Gateway Mobile Location Centre), an operation and maintenance server OAM (Operation And Maintenance), a mobile switching center MME (Mobile Management Entity), and a radio base station eNB.

The positioning server E-SMLC and the positioning server

GMLC are configured to provide an LCS (LoCation Service), that is, the positioning server E-SMLC and the positioning server GMLC are configured to provide the location information (Position Information) of a desired mobile station UE in accordance with a request from the LCS client.

The mobile communication system according to the present embodiment is configured to be able to perform “MDT” in which a target mobile station UE is caused to measure and report a desired radio quality. The “MDT” that can be performed in the mobile communication system according to the present embodiment is assumed to be of two types, namely “Immediate MDT” and “Logged MDT”.

The “Immediate MDT” is “MDT” according to which the desired radio quality is measured and reported by a target mobile station UE in an RRC_Connected state (Active state). In 3GPP, determining the stipulation of the “Immediate MDT” by expanding the existing stipulation of “Measurement” is being examined.

For example, according to the “Immediate MDT”, a target mobile station UE in the RRC_Connected state may be configured to report the measurement result of the desired radio quality, when the reporting condition predetermined by “Reporting Configuration (Event, Period and the like)” is satisfied.

On the other hand, the “Logged MDT” is “MDT” according to which the desired radio quality is measured and reported by a target mobile station UE in an RRC_Idle state.

For example, according to the “Logged MDT”, a target mobile station UE in the RRC_Idle state may be configured to store the measurement result of the desired radio quality, and then report the measurement result at the time of transition to the RRC_Connected state.

In the present embodiment, a case where the mobile station UE is a target mobile station UE that must perform the “MDT” is explained as an example. In the present embodiment, the upper node indicates the mobile switching center MME or the operation and maintenance server OAM.

As illustrated in FIG. 2, the mobile station UE includes a reception unit 11, a location information acquisition unit 12, a measurement unit 13, and a transmission unit 14.

The reception unit 11 is configured to receive various signals transmitted by the radio base station eNB.

The location information acquisition unit 12 is configured to acquire the location information of the target mobile station UE from the positioning server E-SMLC, by using the LCS service, when the execution of “MDT” based on the “MDT policy” is instructed by the radio base station eNB, that is, when “MDT measurement and reporting configuration” is received by the reception unit 11.

The measurement unit 13 is configured to measure the desired radio quality instructed by the “MDT policy” included in the “MDT measurement and reporting configuration” received by the reception unit 11, that is, the measurement unit is configured to perform the “MDT measurement”.

The transmission unit 14 is configured to transmit, to the radio base station eNB, the measurement result of the desired radio quality by the measurement unit 13 and the location information of the mobile station UE that is acquired by the location information acquisition unit 12.

For example, the transmission unit 14 is configured to transmit, to the radio base station eNB, an “MDT measurement result” including the measurement result of the desired radio quality by the measurement unit 13 and the location information of the mobile station UE that is acquired by the location information acquisition unit 12.

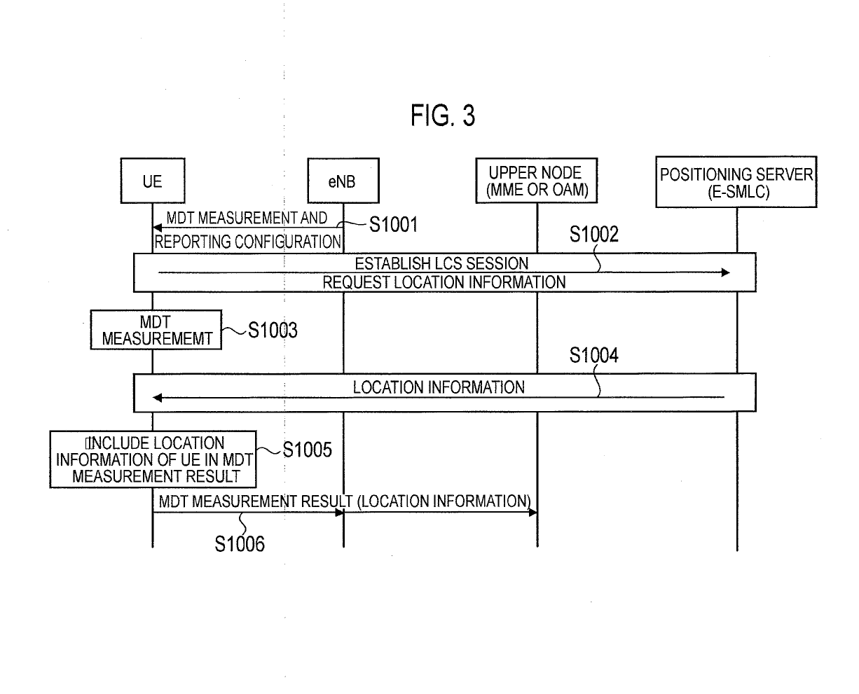

With reference to FIG. 3, the operation of the mobile communication system according to the present embodiment will be explained, below.

As illustrated in FIG. 3, in step S1001, the radio base station eNB transmits an “MDT measurement and reporting configuration” to the mobile station UE.

In step S1002, the mobile station UE establishes an LCS session with the positioning server E-SMLC, and requests the positioning server E-SMLC for the location information of the mobile station UE, and at the same time, in step S1003, the mobile station UE performs the measurement processing (MDT measurement) according to “MDT”.

In step S1004, when the mobile station UE acquires the location information of the mobile station UE from the positioning server E-SMLC, then in step S1005, the mobile station UE generates an “MDT measurement result” including the measurement result of the desired radio quality (result of the measurement processing according to “MDT”) and the location information of the mobile station UE.

In step S1006, the mobile station UE transmits the “MDT measurement result” to the radio base station eNB, and the radio base station eNB transmits the “MDT measurement result” to the upper node MME or OAM.

According to the mobile communication system of the present embodiment, because the target mobile station UE is configured to report the location information of the target mobile station UE along with the measurement result of the desired radio quality, accurate “MDT” can be implemented.

(Mobile Communication System According to Second Embodiment of the Present Invention)

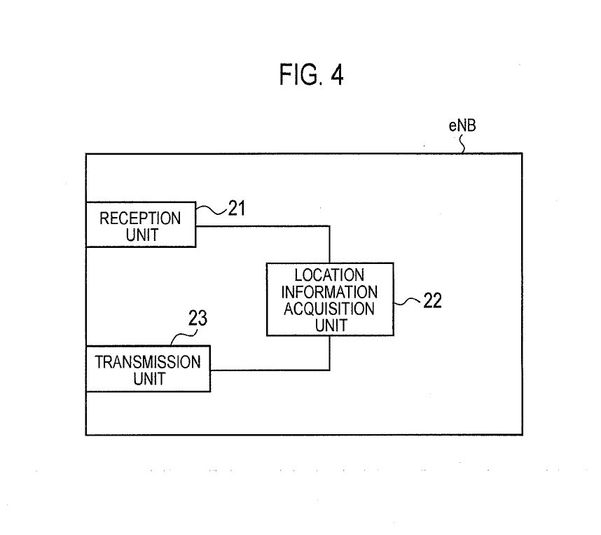

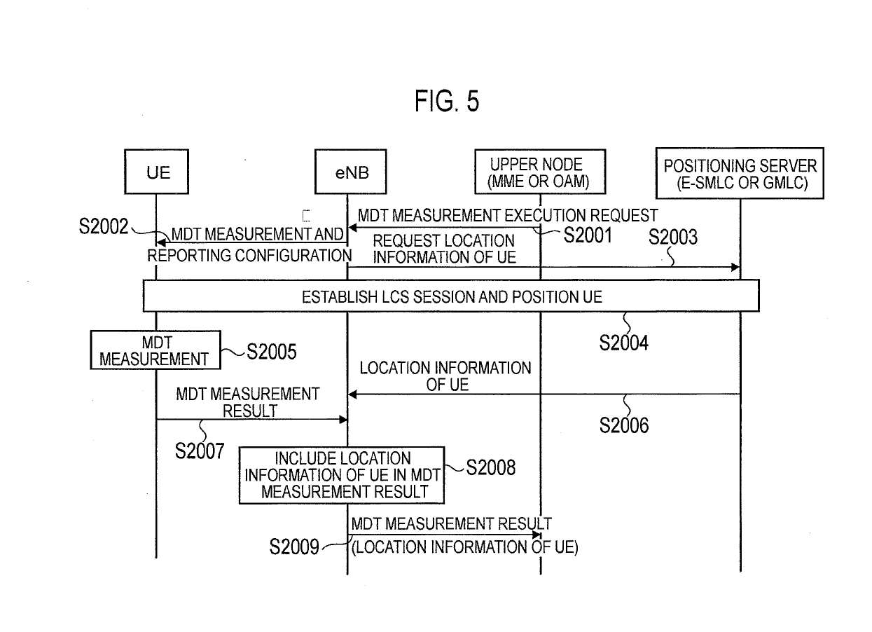

With reference to FIG. 4 and FIG. 5, the configuration of a mobile communication system according to a second embodiment of the present invention will be explained. Hereinafter, the mobile communication system according to the present embodiment will be described while focusing on the difference from the above-mentioned mobile communication system according to the first embodiment.

As illustrated in FIG. 4, according to the mobile communication system of the present embodiment, the radio base station eNB includes a reception unit 21, a location information acquisition unit 22, and a transmission unit 23.

The reception unit 21 is configured to receive various signals transmitted by the mobile station UE and the upper node MME or OAM.

The location information acquisition unit 22 is configured to acquire the location information of the mobile station UE from the positioning server E-SMLC or GMLC, by using the LCS service, when the mobile station UE is instructed to perform “MDT” based on the “MDT policy”.

In such a case, the radio base station eNB is configured to acquire the location information of the mobile station UE from the positioning server E-SMLC or GMLC, as an LCS client.

The transmission unit 23 is configured to transmit, to the upper node MME or OAM, the measurement result of the desired radio quality received from the mobile station UE, and the location information of the mobile station UE acquired from the positioning server E-SMLC or GMLC.

For example, the transmission unit 23 is configured to transmit, to the upper node MME or OAM, an “MDT measurement result” including the measurement result of the desired radio quality received from the mobile station UE, and the location information of the mobile station UE acquired from the positioning server E-SMLC or GMLC.

With reference to FIG. 5, the operation of the mobile communication system according to the present embodiment will be explained, below.

As illustrated in FIG. 5, in step S2001, the upper node MME or OAM transmits an “MDT measurement execution request” including the “MDT policy” to the radio base station eNB.

In step S2002, the radio base station eNB transmits the “MDT measurement and reporting configuration” to the mobile station UE, and at the same time, in step S2003, the radio base station eNB requests the positioning server E-SMLC or GMLC for the location information of the mobile station UE, as an LCS client.

The radio base station eNB may also request the positioning server E-SMLC or GMLC for the location information of the mobile station UE, via an LPPa (LTE Positioning Protocol A) interface stipulated between the radio base station eNB and the positioning server E-SMLC.

In step S2004, the positioning server E-SMLC or GMLC establishes an LCS session with the mobile station UE, and measures the location information of the mobile station UE.

In step S2005, the mobile station UE performs the measurement processing (MDT measurement) according to “MDT”.

In step S2006, the positioning server E-SMLC or GMLC transmits the location information of the mobile station UE to the radio base station eNB, and in step S2007, the mobile station UE transmits an “MDT measurement result” including the measurement result of the desired radio quality (result of the measurement processing according to “MDT”) to the radio base station eNB.

In step S2008, the radio base station eNB generates an “MDT measurement result” including the measurement result of the desired radio quality and the location information of the mobile station UE, and in step S2009, the radio base station eNB transmits the “MDT measurement result” to the upper node MME or OAM.

According to the mobile communication system of the present embodiment, because the upper node MME or OAM is configured to acquire the location information of the target mobile station UE along with the measurement result of the desired radio quality from the target mobile station UE, accurate “MDT” can be implemented.

(Mobile Communication System According to Third Embodiment of the Present Invention)

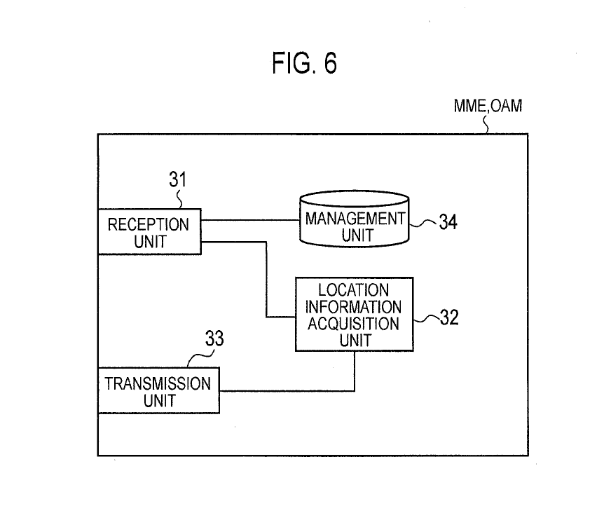

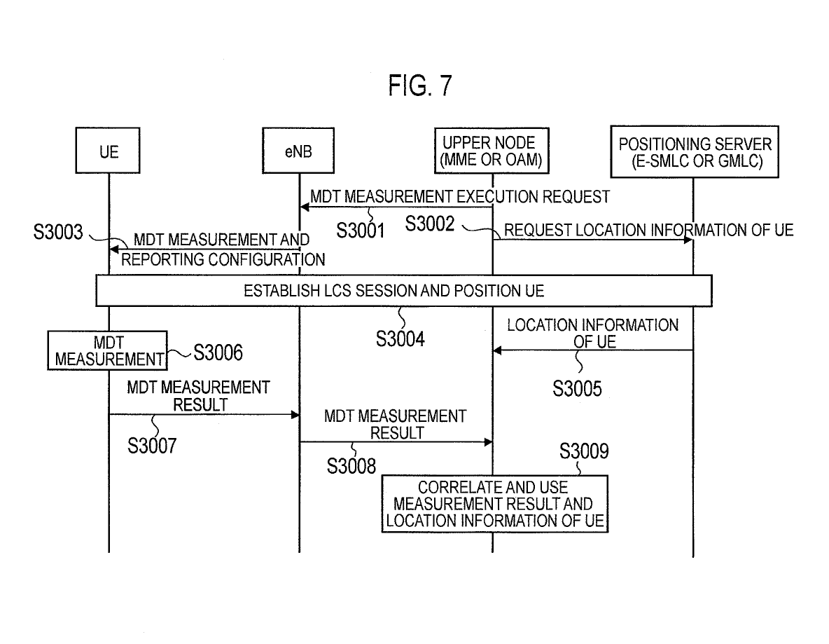

With reference to FIG. 6 and FIG. 7, the configuration of a mobile communication system according to a third embodiment of the present invention will be explained. Hereinafter, the mobile communication system according to the present embodiment will be described while focusing on the difference from the above-mentioned mobile communication system according to the first embodiment.

As illustrated in FIG. 6, according to the mobile communication system of the present embodiment, the upper node MME or OAM includes a reception unit 31, a location information acquisition unit 32, a transmission unit 23, and a management unit 34.

The reception unit 31 is configured to receive various signals transmitted by the radio base station eNB, and the transmission unit 33 is configured to transmit the various signals to the radio base station eNB.

The location information acquisition unit 32 is configured to acquire the location information of the mobile station UE from the positioning server E-SMLC or GMLC, by using the LCS service, when the “MDT policy” is notified to the radio base station eNB, that is, when an “MDT measurement execution request” is transmitted by the transmission unit 33.

In such a case, the upper node MME or OAM is configured to acquire the location information of the mobile station UE from the positioning server E-SMLC or GMLC, as an LCS client.

The management unit 34 is configured to correlate and manage the measurement result of the desired radio quality (result of the measurement processing according to “MDT”) included in the “MDT measurement result” from the radio base station eNB received by the reception unit 31, and the location information of the mobile station UE acquired from the positioning server E-SMLC or GMLC.

With reference to FIG. 7, the operation of the mobile communication system according to the present embodiment will be explained, below.

As illustrated in FIG. 7, in step S3001, the upper node MME or OAM transmits an “MDT measurement execution request” including the “MDT policy” to the radio base station eNB, and at the same time, in step S3002, the upper node MME or OAM requests the positioning server E-SMLC or GMLC for the location information of the mobile station UE, as an LCS client.

When the upper node is the mobile switching center MME, the upper node may request the positioning server E-SMLC for the location information of the mobile station UE, via an S-Ls interface stipulated between the mobile switching center MME and the positioning server E-SMLC.

On the other hand, when the upper node is the operation and maintenance server OAM, the upper node may request the positioning server E-SMLC for the location information of the mobile station UE, via the mobile switching center MME, or a new interface stipulated between the operation and maintenance server OAM and the positioning server E-SMLC.

In step S3003, the radio base station eNB transmits an “MDT measurement and reporting configuration” to the mobile station UE.

In step S3004, the positioning server E-SMLC or GMLC establishes an LCS session with the mobile station UE, and measures the location information of the mobile station UE, and in step S3005, the positioning server E-SMLC or GMLC transmits the location information of the mobile station UE to the upper node MME or OAM.

In step S3006, the mobile station UE performs the measurement processing (MDT measurement) according to “MDT”, and in step S3007, the mobile station UE transmits an “MDT measurement result” including the measurement result of the desired radio quality (result of the measurement processing according to “MDT”) to the radio base station eNB.

In step S3008, the radio base station eNB transmits the “MDT measurement result” to the upper node MME or OAM.

In step S3009, the upper node MME or OAM correlates and manages the measurement result of the desired radio quality (result of the measurement processing according to “MDT”) included in the “MDT measurement result” received from the mobile station UE via the radio base station eNB, and the location information of the mobile station UE acquired from the positioning server E-SMLC or GMLC.

According to the mobile communication system of the present embodiment, because the upper node MME or OAM is configured to acquire the location information of the target mobile station UE along with the measurement result of the desired radio quality from the target mobile station UE, accurate “MDT” can be implemented.

The characteristics of the aforementioned embodiments may be represented as below.

A first characteristic of the present invention is summarized as a mobile communication method in which a target mobile station UE is caused to measure and report a desired radio quality, and which includes a step of instructing the target mobile station UE, by a radio base station eNB, to perform “MDT (measurement and reporting of the desired radio quality)” based on an “MDT policy (a method of measuring and reporting the desired radio quality)”, a step of acquiring, by the target mobile station UE, from a positioning server E-SMLC, the location information of the target mobile station UE, and a step of transmitting, by the target mobile station UE, to the radio base station eNB, the measurement result of the desired radio quality and the location information of the target mobile station UE.

A second characteristic of the present invention is summarized as a mobile station UE capable of functioning as a target mobile station UE in a mobile communication method in which the target mobile station UE is caused to measure and report a desired radio quality, and which includes a location information acquisition unit 12 configured to acquire the location information of the target mobile station UE, from a positioning server E-SMLC, when instructed to perform “MDT” based on an “MDT policy”, and a transmission unit 14 configured to transmit, to a radio base station eNB, the measurement result of the desired radio quality and the location information of the target mobile station UE.

A third characteristic of the present invention is summarized as a mobile communication method in which a target mobile station UE is caused to measure and report a desired radio quality, and which includes a step of acquiring, from a positioning server E-SMLC or GMLC, the location information of the target mobile station UE, when a radio base station eNB instructs the target mobile station UE to perform “MDT” based on an “MDT policy”, a step of transmitting, by the target mobile station UE, to the radio base station eNB, the measurement result of the desired radio quality, and a step of transmitting, by the radio base station eNB, to an upper node MME or OAM, the measurement result of the desired radio quality received from the target mobile station UE, and the location information of the target mobile station UE acquired from the positioning server E-SMLC or GMLC.

A fourth characteristic of the present invention is summarized as a radio base station eNB used in a mobile communication method in which a target mobile station UE is caused to measure and report a desired radio quality, and which includes a location information acquisition unit 22 configured to acquire the location information of the target mobile station UE, from a positioning server E-SMLC or GMLC, when the target mobile station UE is instructed to perform “MDT” based on an “MDT policy”, and a transmission unit 23 configured to transmit, to an upper node MME or OAM, the measurement result of the desired radio quality received from the target mobile station UE, and the location information of the target mobile station UE acquired from the positioning server E-SMLC or GMLC.

A fifth characteristic of the present invention is summarized as a mobile communication method in which a target mobile station UE is caused to measure and report a desired radio quality, and which includes a step of acquiring, from a positioning server E-SMLC or GMLC, the location information of the target mobile station UE, when an upper node MME or OAM notifies a radio base station eNB of an “MDT policy”, a step of instructing the target mobile station UE, by the radio base station eNB, to perform “MDT” based on the “MDT policy”, a step of transmitting, by the target mobile station UE, to the radio base station eNB, the measurement result of the desired radio quality, and a step of transmitting, by the radio base station eNB, to the upper node MME or OAM, the measurement result of the desired radio quality received from the target mobile station UE.

A sixth characteristic of the present invention is summarized as an upper node MME or OAM used in a mobile communication method in which a target mobile station UE is caused to measure and report a desired radio quality, and which includes a location information acquisition unit 32 configured to acquire the location information of the target mobile station UE, from a positioning server E-SMLC or GMLC, when the radio base station eNB is notified of an “MDT policy”, and a reception unit 33 configured to receive the measurement result of the desired radio quality from the target mobile station UE via the radio base station eNB.

It should be noted that the aforementioned operation of the mobile station UE, the radio base station eNB, the mobile switching center MME, or the operation and maintenance server OAM may be performed by hardware, a software module executed by a processor, or a combination thereof.

The software module may be arranged in a storage medium of an arbitrary format such as a RAM (Random Access Memory), a flash memory, a ROM (Read Only Memory), an EPROM (Erasable Programmable ROM), an EEPROM (Electronically Erasable and Programmable ROM), a register, a hard disk, a removable disk, or a CD-ROM.

The storage medium is connected to the processor so that the processor can write and read information into and from the storage medium. Such a storage medium may also be accumulated in the processor. Such storage medium and processor may be arranged in an ASIC. The ASIC may be provided in the mobile station UE, the radio base station eNB, the mobile switching center MME, or the operation and maintenance server OAM. Furthermore, such storage medium and processor may be provided in the mobile station UE, the radio base station eNB, the mobile switching center MME, or the operation and maintenance server OAM as discrete components.

Thus, the present invention has been explained in detail by using the above-described embodiments; however, it is obvious that for persons skilled in the art, the present invention is not limited to the embodiments explained herein. The present invention can be implemented as a corrected and modified mode without departing the gist and the scope of the present invention defined by the claims. Therefore, the description of the specification is intended for explaining the example only and does not impose any limited meaning to the present invention.

### INDUSTRIAL APPLICABILITY

As described above, according to the present invention, it is possible to provide a mobile communication method with which it is possible to acquire accurate location information of a target mobile station UE, along with a measurement result, by causing the target mobile station UE to measure accurately a desired radio quality, and to provide a mobile station thereof, a radio base station thereof, and an upper node thereof.

### REFERENCE SIGNS LIST

UE . . . Mobile station

OAM . . . Operation and maintenance server

E-SMLC, GMLC . . . Positioning server

MME . . . Mobile switching center

eNB . . . Radio base station

11, 21, 31 . . . Reception unit

12, 22, 32 . . . Location information acquisition unit

13 . . . Measurement unit

14, 23, 33 . . . Transmission unit

34 . . . Management unit

1. A mobile communication method in which a target mobile station is caused to measure and report a desired radio quality, the method comprising:
a step of instructing the target mobile station, by a radio base station, to measure and report the desired radio quality based on a method of measuring and reporting the desired radio quality;
a step of acquiring, by the target mobile station, from a positioning server, the location information of the target mobile station; and
a step of transmitting, by the target mobile station, to the radio base station, the measurement result of the desired radio quality and the location information of the target mobile station.

2. A mobile station capable of functioning as a target mobile station in a mobile communication method in which the target mobile station is caused to measure and report a desired radio quality, the mobile station comprising:
a location information acquisition unit configured to acquire the location information of the target mobile station, from a positioning server, when instructed to measure and report the desired radio quality based on a method of measuring and reporting the desired radio quality; and
a transmission unit configured to transmit, to a radio base station, the measurement result of the desired radio quality and the location information of the target mobile station.

3. A mobile communication method in which a target mobile station is caused to measure and report a desired radio quality, the method comprising:
a step of acquiring, from a positioning server, the location information of the target mobile station, when a radio base station instructs the target mobile station to measure and report the desired radio quality based on a method of measuring and reporting the desired radio quality;
a step of transmitting, by the target mobile station, to the radio base station, the measurement result of the desired radio quality; and
a step of transmitting, by the radio base station, to an upper node, the measurement result of the desired radio quality received from the target mobile station, and the location information of the target mobile station acquired from the positioning server.

4. A radio base station used in a mobile communication method in which a target mobile station is caused to measure and report a desired radio quality, comprising:
a location information acquisition unit configured to acquire the location information of the target mobile station, from a positioning server, when the target mobile station is instructed to measure and report the desired radio quality based on a method of measuring and reporting the desired radio quality; and
a transmission unit configured to transmit, to an upper node, the measurement result of the desired radio quality received from the target mobile station, and the location information of the target mobile station acquired from the positioning server.

5. A mobile communication method in which a target mobile station is caused to measure and report a desired radio quality, the method comprising:
a step of acquiring, from a positioning server, the location information of the target mobile station, when an upper node notifies a radio base station of a method of measuring and reporting the desired radio quality;
a step of instructing the target mobile station, by the radio base station, to measure and report the desired radio quality based on the method of measuring and reporting the desired radio quality;
a step of transmitting, by the target mobile station, to the radio base station, the measurement result of the desired radio quality; and
a step of transmitting, by the radio base station, to the upper node, the measurement result of the desired radio quality received from the target mobile station.

6. An upper node used in a mobile communication method in which a target mobile station is caused to measure and report a desired radio quality, comprising:
a location information acquisition unit configured to acquire the location information of the target mobile station, from a positioning server, when the radio base station is notified of a method of measuring and reporting the desired radio quality; and
a reception unit configured to receive the measurement result of the desired radio quality from the target mobile station via the radio base station.
